(19) United States
(12) Patent Application Publication
(10) Pub. No.: US 2025/0113957 A1
(43) Pub. Date: Apr. 10, 2025

(54) Vacuum with Magnetic and Coarse Material Uptake Surface Primer

(71) Applicant: Joginder S. Sidhu, Los Angeles, CA (US)

(72) Inventor: Joginder S. Sidhu, Los Angeles, CA (US)

(21) Appl. No.: 18/376,814

(22) Filed: Oct. 4, 2023

(51) Int. Cl. A47L 9/10; A47L 5/28; A47L 9/06; B03C 1/30; H01F 7/02

(52) U.S. Cl. CPC A47L 9/104; A47L 5/28; A47L 9/066; A47L 9/068; A47L 9/0693; B03C 1/30; B03C 2201/20; H01F 7/02

(57) ABSTRACT

A vacuum apparatus with a magnetic and coarse material uptake surface primer for separating magnetic materials, non-magnetic coarse materials, and fine materials includes an intake housing having a magnetic element, a coarse material guide, a coarse material uptake portal and a fine material intake. The coarse material uptake portal is positioned between the magnetic element and the fine material intake. A storage chamber for holding the non-magnetic coarse materials is included, along with a release mechanism positioned such that the magnetic element adheres the magnetic materials to the release mechanism, and moving the release mechanism away from the magnetic element permits the magnetic materials to separate from the magnetic element.

### FIELD OF THE INVENTION

The present invention relates to vacuums and vacuuming, including household vacuums. More specifically the invention relates to a vacuum cleaner capable of taking up, separating, and retaining magnetic materials, coarse materials, and fine particulates.

### BACKGROUND

Vacuums, including household vacuum cleaners for indoor domestic use are well known and have long been in use. These machines typically have a body portion with a motorized impeller, filter and collection bag, along with an intake housing flexibly connected to the body portion. The intake housing generally includes rollers that maintain the intake housing at a low profile relative to a surface to be cleaned by the vacuum cleaner. One element of the intake housing is typically a slot bearing a rotating beater bar, which may include bristles for agitating or sweeping up dirt and detritus from the surface. The slot is generally narrowed in profile to increase negative air pressure and enhance the vacuum cleaner's effectiveness.

One persistent problem with conventional vacuum cleaners caused by the narrow slot and low profile intake housing is the inability to pick up larger, coarse materials having a height or diameter larger than a few millimeters. Conventional vacuum cleaners tend to simply push these materials out of the way, or allow them to become lodged in the intake housing machinery. Thus, cleaning a surface with coarse and fine materials becomes a two-step process involving first sweeping the surface to pick up large debris and then vacuuming, which is inconvenient and time consuming.

Another problem with conventional vacuum cleaners occurs when they encounter metallic objects, such as nails, tacks, paperclips, or the like. These objects often can be small enough to pass under the intake housing, but are not handled well by the beater bar. A common experience when operating a vacuum cleaner is the undesirable noise associated with a piece of metallic debris chaotically circulating with the beater bar and failing to enter the collection bag. Aside from the annoyance caused by this problem, metallic objects circulating with a beater bar can, over time, damage the belt or other operational machinery in the intake housing driving the beater bar. Removing these items, along with coarse, non-magnetic items from the intake housing is also inconvenient and time consuming.

For these reasons it is an object of the present invention to provide an apparatus that removes coarse non-magnetic materials from a surface before collecting fine materials. Another object of the invention is to provide an apparatus that removes magnetic metallic materials from the surface before collecting fine materials. These and other objects are more fully described in the following summary, detailed description, and drawings.

### SUMMARY

In one embodiment, a vacuum apparatus is provided having a magnetic and coarse material uptake surface primer which separates magnetic materials, non-magnetic coarse materials, and fine materials from a surface to be vacuumed. The apparatus includes an intake housing having a magnetic element, a coarse material guide, a coarse material uptake portal and a fine material intake, with the coarse material uptake portal positioned between the magnetic element and the fine material intake. A first storage chamber is provided for receiving non-magnetic material.

A release mechanism is positioned at the front of the intake such that the magnetic element adheres the magnetic materials from the surface to the release mechanism. Thus, moving the release mechanism away from the magnetic element permits the magnetic materials to fall away from the magnetic element to a tray or catchment of the user's choosing for disposal. Preferably, the release mechanism is a ferro-magnetic plate, or similar material capable of transmitting a magnetic field. The release mechanism may also be coupled to the intake housing with a hinge allowing it to swing in and out of a collecting/releasing position. In one alternative embodiment, the apparatus may have a plurality of magnetic elements.

To ensure maximum uptake, of the magnetic materials, the release mechanism preferably spans a front bumper of the intake housing. For efficient gathering and uptake of the non-magnetic coarse materials, the apparatus may include a coarse material guide between the magnetic element and the fine material intake. In one preferred embodiment, the coarse material guide takes the form of a pair of angled coarse material guides that direct the non-magnetic coarse materials toward the coarse material uptake portal, which may be centrally located in the intake housing.

In addition to the first storage chamber for receiving the non-magnetic coarse material, the apparatus may include a second storage chamber for receiving the fine materials. In one embodiment, a coarse material uptake hose is provided between the coarse material uptake portal and the first storage chamber for transporting the non-magnetic coarse materials therethrough. A fine material uptake hose may be provided between the fine material intake and the second storage chamber for transporting the fine materials therethrough.

The apparatus can also be characterized as a vacuum having a magnetic and coarse material uptake surface primer for separating magnetic materials, non-magnetic coarse materials, and fine materials from a surface, with a main body portion having a coarse material storage chamber and a fine material storage chamber. In this embodiment, an intake housing having a top portion spanning a first sidewall and a second sidewall is provided. The top portion is in fluid communication with the coarse material storage chamber and the fine material storage chamber.

The top portion includes a magnetic element configured to adhere the magnetic materials to a release mechanism, such that moving the release mechanism away from the magnetic element causes the release mechanism to release the magnetic materials. Preferably, the release mechanism is a ferro-magnetic plate, and may be coupled to the intake housing with a hinge. In one embodiment, the vacuum may have a plurality of magnetic elements. The release mechanism may also span the first sidewall and the second sidewall to maximize its collecting ability.

In some embodiments, a coarse material guide may be placed between the magnetic element and the coarse material storage chamber for collecting non-magnetic coarse materials. The coarse material guide may be a pair of angled coarse material guides configured to direct the non-metallic coarse materials toward a coarse material vacuum uptake portal in communications with the coarse material storage chamber. In order to assist with air flow and the collection of coarse magnetic and non-magnetic materials the first sidewall and the second sidewall extend beyond the top portion. Additionally, the coarse material storage chamber and the fine material storage chamber may be in fluid communication with a common filter.

A method of providing an apparatus for removing and separating magnetic materials, non-magnetic coarse materials, and fine materials from a surface is also disclosed. The method includes the steps of providing a motorized induction fan and filter, and providing a coarse material storage chamber and a fine material storage chamber. A coarse material uptake portal is provided, along with a fine material vacuum intake. These are configured such that the non-magnetic coarse materials encounter the coarse material uptake portal before the fine materials encounter the fine material vacuum intake when the apparatus passes across a surface.

A magnetic element is provided and configured such that the magnetic materials encounter the magnetic element before the coarse material uptake portal and fine material vacuum intake when the apparatus passes across a surface. A release mechanism is then provided and configured such that moving the release mechanism away from the magnetic element releases the magnetic materials.

### BRIEF DESCRIPTION OF THE FIGURES

FIG. 1 illustrates a perspective view of an improved vacuum cleaner having a magnetic and coarse material uptake surface priming feature.

FIG. 2 illustrates a bottom perspective view of the vacuum cleaner intake housing in a magnetic material collecting position.

FIG. 3 illustrates a bottom perspective view of the vacuum cleaner intake housing in a magnetic material discharging position.

FIG. 4 illustrates a front view of the vacuum cleaner intake housing.

FIG. 5 illustrates a horizontal section view of the vacuum cleaner intake housing.

FIG. 6 illustrates a vertical section view of the vacuum cleaner including the paths of airflow therethrough.

FIG. 7 illustrates a vertical section view of the vacuum cleaner approaching debris to be removed from a surface.

FIG. 8 illustrates a vertical section view of the vacuum cleaner selectively removing magnetic, coarse non-magnetic, and fine debris from the surface.

FIG. 9 illustrates a vertical section view of the vacuum cleaner containing the magnetic, coarse non-magnetic, and fine debris removed from the surface.

FIG. 10 illustrates a vertical section view the vacuum cleaner in the process of discharging magnetic materials.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure or material to the teachings of the disclosure without departing from the essential scope thereof.

The drawings accompanying the application are for illustrative purposes only, and are not intended to limit embodiments of the application. Additionally, the drawings may not be to scale. Common elements between different figures may retain the same numerical designation.

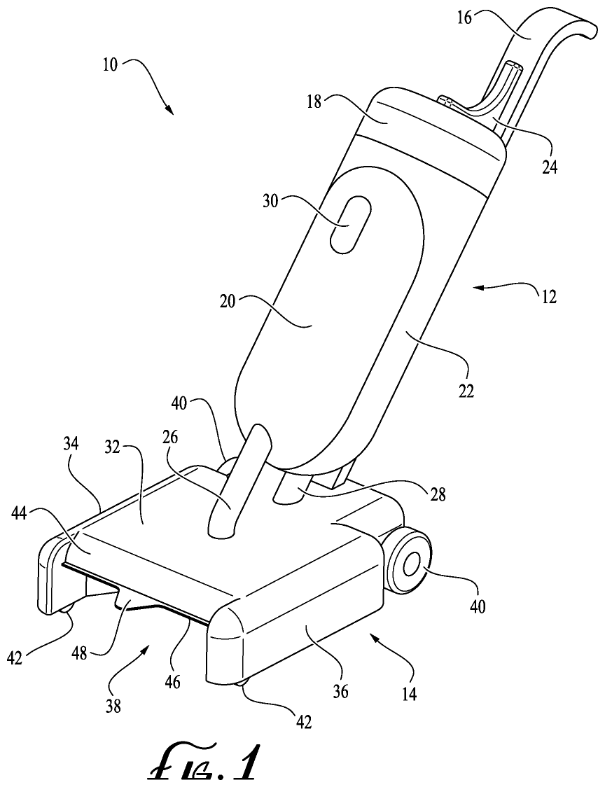

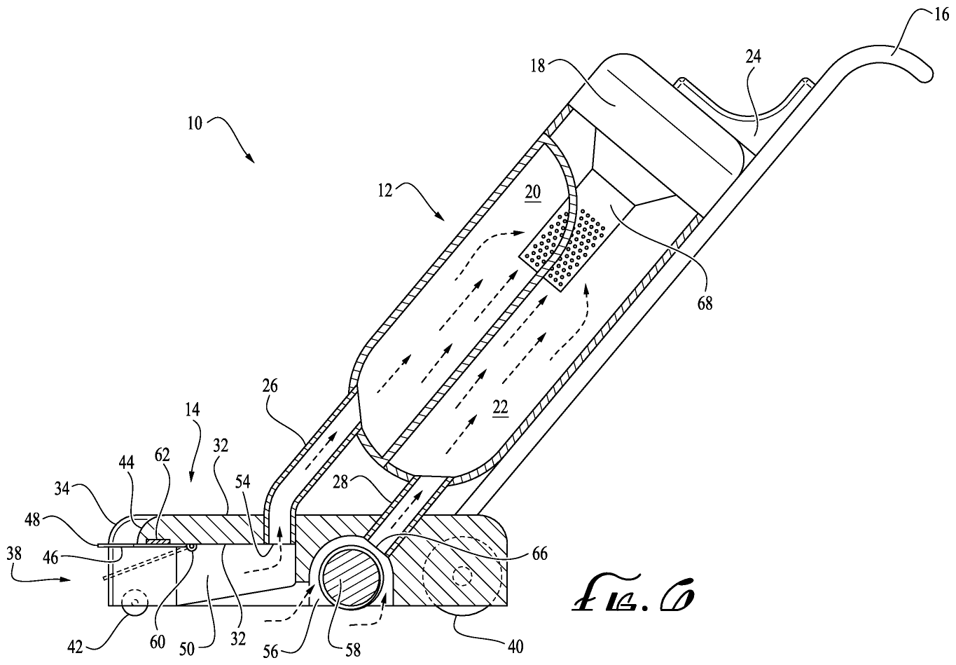

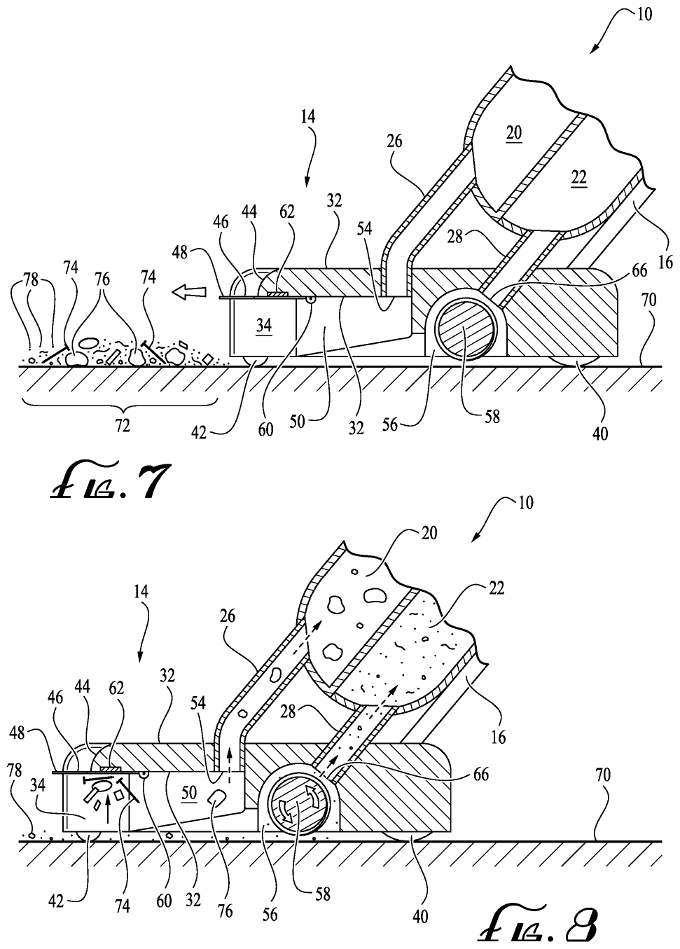

Referring to FIG. 1, a vacuum cleaner 10 with a magnetic and non-magnetic coarse material removal surface priming feature includes a main body 12 and an intake housing 14. The main body 12 is coupled to a handle 16 for driving the vacuum cleaner 10. The main body 12 comprises a motor housing 18, a filter 68 (FIG. 6), a coarse material storage chamber 20, and a fine material storage chamber 22, along with other customary vacuum cleaner components such as a power on/off control, handle release pedal, tool storage, and power cord storage, etc. (not shown). A retaining bracket 24 may be included for connecting and retaining the main body 12 against the handle 16 and enabling it to be removed to discard vacuumed detritus 72 (FIG. 7) taken up by the vacuum cleaner 10.

Still referring to FIG. 1, the handle 16 connects the main body 12 to the intake housing 14. The coarse material storage chamber 20 and the fine material storage chamber 22 of the main body 12 are in communication with the intake housing 14 via a coarse material uptake hose 26 and a fine material uptake hose 28. Although individual hoses are shown in the illustrated embodiment, it should be understood that any communicating structure(s) permitting vacuumed detritus 72 to move under pressure from the intake housing 14 to the main body 12 is contemplated. Additionally, the coarse material storage chamber 20 and the fine material storage chamber 22 may be separately removable since they may fill to capacity at different rates. In one embodiment, the main body 12 may include a window 30 for assessing the capacity of the coarse material storage chamber 20.

In one embodiment, the intake housing 14 includes a top portion 32 to which the coarse material uptake hose 26 may be connected, along with the fine material uptake hose 28. The top portion 32 is elevated by a first sidewall 34 and an opposing second sidewall 36. The top portion 32, along with the first sidewall 34 and the second sidewall 36 together define an intake 38, through which vacuumed detritus 72 passes when the vacuum cleaner 10 is activated and rolled across a surface 70 (FIGS. 7-10) to be cleaned.

To facilitate rolling across the surface 70, the vacuum cleaner 10 may have rear casters 40 opposite the intake, below the handle 16, and front casters 42 under the first sidewall 34 and the second sidewall 36. In the illustrated embodiment, the rear casters 40 are larger than the front casters 42, although any arrangement of rolling equipment is anticipated that would allow the intake 38 to pass over vacuumed detritus 72 on a variety of surfaces.

The intake housing 14 includes a front bumper 44 which, in the illustrated embodiment is positioned slightly inward of the first sidewall 34 and the second sidewall 36. A release mechanism 46 is provided adjacent the front bumper 44 for releasing magnetic materials 74 (FIG. 8) taken up by the vacuum cleaner 10. In one embodiment, wherein the release mechanism 46 is manually operated, the release mechanism 46 may include a tab 48 allowing a user to manipulate the release mechanism 46.

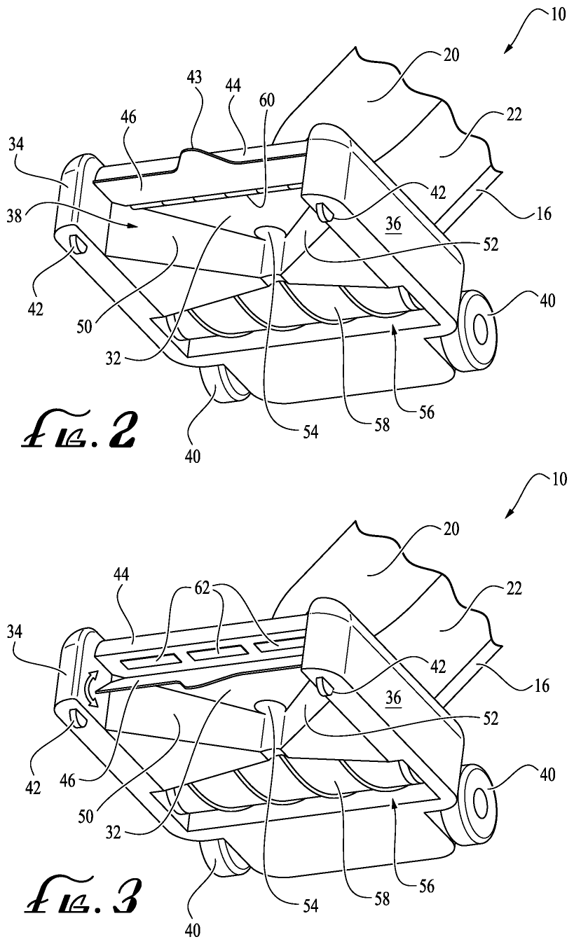

Referring to FIG. 2, the intake housing 14 is shown from below. Under the top portion 32, the intake housing includes a first coarse material guide 50 and a second coarse material guide 52. The first coarse material guide 50 and the second coarse material guide 52 are angled relative to each other, and to the intake 38 such that non-magnetic coarse materials are driven toward a coarse material vacuum uptake portal 54, where suction is at a maximum due to a Venturi effect created by narrowing of the distance between the first coarse material guide 50 and the second coarse material guide 52. Non-magnetic coarse materials 76 (FIG. 8) are driven under negative pressure through the coarse material vacuum uptake portal 54, through the coarse material uptake hose 26 (FIG. 1) and into the coarse material storage chamber 20.

Still referring to FIG. 2, behind the first coarse material guide 50 and the second coarse material guide 52, a fine material vacuum intake 56 is provided, which preferably includes a conventional beater bar 58 and may include other known components such as brushes (not shown) suitable for sand, dust, and other fine granular materials. The release mechanism 46 under the front bumper 44 is preferably affixed to the top portion 32 using a hinge 60. In various alternative embodiments, other types of connections may be used, as long as the release mechanism 46 is permitted to swing down and away from the top portion 32 while remaining connected thereto.

Referring to FIG. 3, in one embodiment, a series of magnetic elements 62 are disposed under the top portion 32 near the front bumper 44. Alternatively, a single magnetic element (not shown) may be provided. In other embodiments, the magnetic elements may be 62 permanent magnets or electromagnetically powered by the vacuum cleaner. In one embodiment, neodymium permanent magnets may be used. The magnetic elements 62 attract magnetic materials 74 when the vacuum cleaner passes over them. In one preferred embodiment, the release mechanism 46 is made of a ferromagnetic material. Thus, the release mechanism 46, when stowed against the magnetic elements 62, is not only retained in position, but also extends the magnetic field of the magnetic elements 62 to capture magnetic materials 74. When the vacuum cleaner 10 is in operation and encounters magnetic materials 74, they are lifted up and captured against the release mechanism 46. When the release mechanism 46 is dislodged from the magnetic elements 62, the magnetic materials 74 are released and fall away from the release mechanism 46.

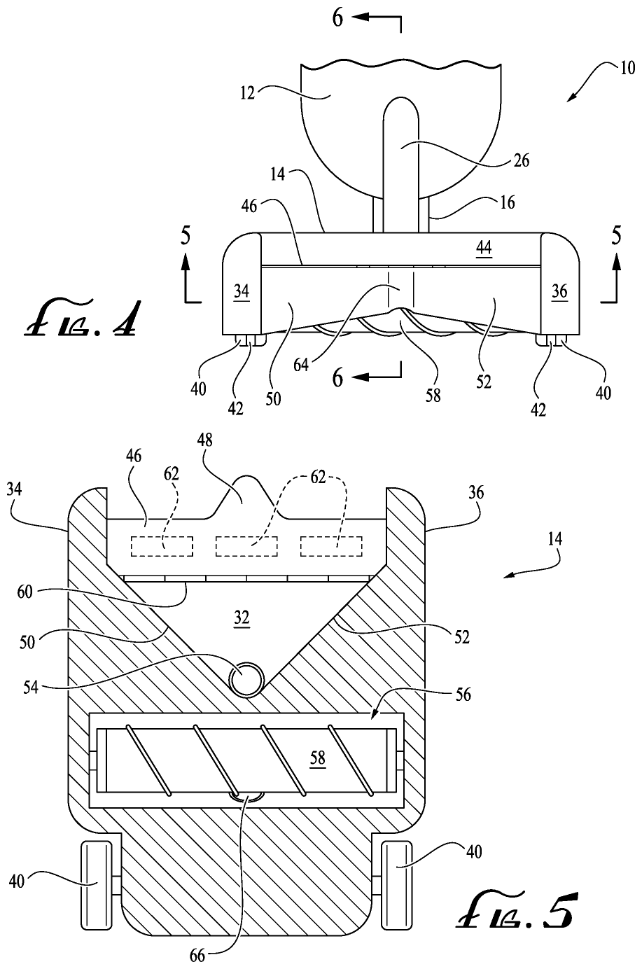

Referring to FIG. 4, the front bumper and release mechanism are preferably suitably elevated such that coarse materials can be maneuvered under the intake housing 14 without obstruction. As these materials pass under the intake housing 14, magnetic materials 74 are separated out by lifting up to be retained against the release mechanism 46. The release mechanism 46 being retained against the magnetic elements 62 and exerting a magnetic pull on the magnetic materials 74. As the vacuum cleaner 10 continues forward non-magnetic coarse materials 76 encounter the first coarse material guide 50 and the second coarse material guide 52, and are driven toward the coarse material vacuum uptake portal 54. In the illustrated embodiment the first coarse material guide 50 and the second coarse material guide 52 have a variable height profile, with the height of each guide being slightly reduced until they convene at a coarse material channel 64 leading to the coarse material vacuum uptake portal 54, as shown in FIG. 3. This slight change in height helps direct non-magnetic coarse materials 76 into the coarse material storage chamber 20 while leaving fine materials 78 (FIG. 7) to be taken up by the fine material vacuum intake 56.

Referring to FIG. 5, a horizontal section view of the intake housing 14 shows the release mechanism installed against the magnetic elements 62, with a hinge 60 connected to the top portion 32. The first coarse material guide 50 and the second coarse material guide 52 together form a delta shape to create the Venturi effect, strengthening the vacuum pressure of air passing through the coarse material vacuum uptake portal 54. Behind the coarse material vacuum uptake portal 54, the fine material vacuum intake 56 is disposed, including the beater bar 58. A fine material vacuum portal 66 above the beater bar takes in fine materials 78 under negative pressure, directing them to the fine material storage chamber 22.

Referring to FIG. 6 a section view of the vacuum cleaner 10 is shown, illustrating air travel through the vacuum cleaner 10. When the vacuum cleaner 10 is powered on, an impeller (not shown) in the motor housing 18 activates drawing air forcefully through the impeller which is then exhausted from the vacuum cleaner 10 in any conventional manner. A filter 68 is provided in advance of the impeller to capture airborne particles from the air passing through the filter 68. In the illustrated embodiment, the filter is disposed partially inside the coarse material storage chamber 20 and partially inside the fine material storage chamber 22. Thus, a single impeller can be used to collect coarse materials and fine materials. In other embodiments, the vacuum cleaner 10 may include multiple dedicated impellers. In still other embodiments, additional air flow controls may be used to vary the pressure of air being drawn through the coarse material storage chamber 20 and the fine material storage chamber 22.

Still referring to FIG. 6, air is pulled into the coarse material storage chamber through the coarse material uptake hose 26, entering through the coarse material vacuum uptake portal 54 after being drawn through the intake 38 of the intake housing 14. Air is also pulled into the fine material storage chamber 22 through the fine material uptake hose 28, entering through the fine material vacuum portal. Negative pressure is increased in the fine material vacuum intake 56 due to its low profile and separation from the intake 38.

Referring to FIGS. 7-10, the vacuum cleaner 10 is shown in use, with the intake housing 14 in section view to show relevant operational components. Operating the vacuum cleaner 10 by the handle 16, a user (not shown) urges the intake housing 14 forward along a surface 70. The surface 70 may be hard and planar, as would be the case with hardwood, tile, or similar flooring, or the surface 70 may be soft, as would be the case with carpet or similar materials. In the event of a carpeted surface, it is anticipated that the intake housing 14 can be raised or lowered relative to the rear casters 40 or front casters 42 (or both) such that the intake housing is a suitable distance from the surface 70.

Referring to FIG. 7, as the intake housing 14 is urged forward along the surface 70, the vacuum cleaner 10 encounters the vacuumed detritus 72. The vacuumed detritus 72 includes several components, including magnetic materials 74, non-magnetic coarse materials 76, and fine materials 78. The magnetic materials 74 may be any small magnetically sensitive metallic objects littered on the floor. Depending on the area to be vacuumed, they may comprise nails, as illustrated. Other common magnetic materials 74 may include tacks, paperclips, bottle caps, or any other small metallic objects which are too coarse to be taken up by a conventional vacuum cleaner. The non-magnetic coarse materials 76 include any non-magnetic particulates too large to be taken up by a conventional vacuum cleaner. The size of the non-magnetic coarse materials 76 is only limited by the aperture size of the coarse material vacuum uptake portal 54. The fine materials 78 are the remaining dust, dirt, and other fine granular materials that can be taken up by a conventional vacuum cleaner, and which are removed from the surface 70 by the fine material vacuum intake 56 and beater bar 58.

Referring to FIG. 8, as the intake housing 14 passes over the vacuumed detritus 72, the magnetic materials 74 are lifted from the surface 70 and adhere to the release mechanism 46 by virtue of the magnetic elements 62 exerting a magnetic force through the release mechanism 46. The magnetic materials remain adhered to the release mechanism 46 as long as it remains connected to the magnetic elements 62. The non-magnetic coarse materials 76 are urged closer to the coarse material vacuum uptake portal 54 as they encounter the first coarse material guide 50 (and second coarse material guide 52) which drive them toward the center of the intake housing 14.

Still referring to FIG. 8, the non-magnetic coarse materials travel under pressure through the coarse material vacuum uptake portal 54, through the coarse material uptake hose and into the coarse material storage chamber 20. The remaining fine materials 78 travel under the first coarse material guide 50 and the second coarse material guide 52 and are taken up by the fine material vacuum intake 56 and beater bar 58 in the manner of a conventional vacuum cleaner. The fine materials 78 travel through the fine material uptake hose 28 and are deposited in the fine material storage chamber.

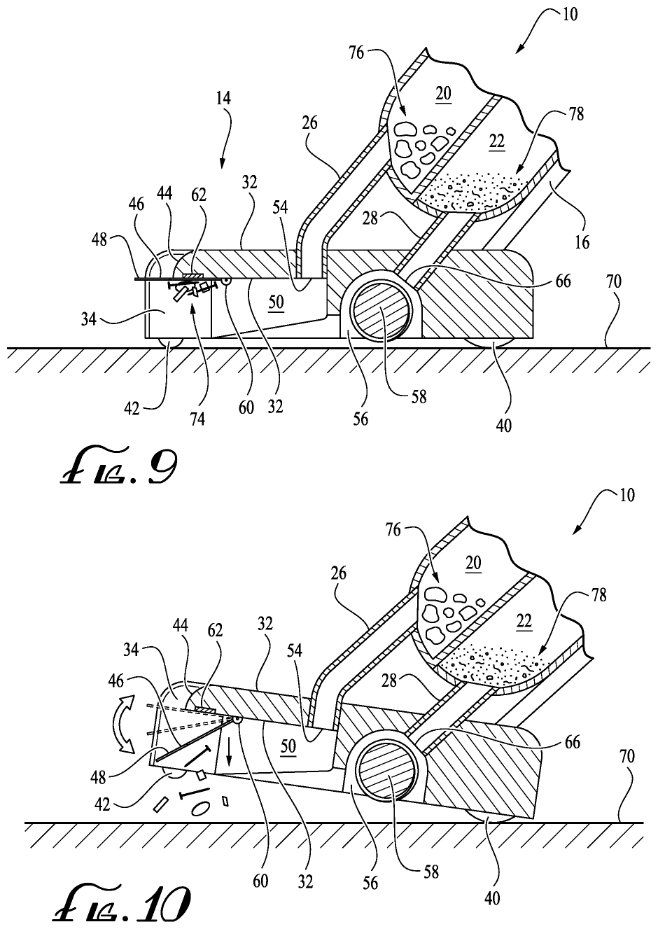

FIG. 9 shows the vacuum cleaner 10 having passed over the surface 70 and collected the vacuumed detritus 72, which is separated into the magnetic materials 74, non-magnetic coarse materials 76, and fine materials 78. The vacuumed detritus can be individually discarded. For example, the non-magnetic coarse materials may represent only a fraction of the vacuumed detritus 72 collected by the vacuum cleaner 10. Accordingly, the fine material storage chamber 22 is likely to fill up before the coarse material storage chamber 20, and can be individually emptied as need. In contrast, the coarse material storage chamber 20 can be individually emptied as necessary. The magnetic materials 74 can also be individually removed, either after each use, or when sufficient magnetic materials 74 have collected on the release mechanism 46.

Referring to FIG. 10, when sufficient magnetic materials 74 have adhered to the release mechanism 46, a user may grasp the tab 48 and urge the release mechanism away from the magnetic elements 62. This has the effect of weakening the magnetic field effect on the magnetic materials 74, which will naturally fall away from the release mechanism 46 and magnetic elements 62. It is anticipated that a dustpan (not shown) or other catchment may be employed to catch the magnetic materials 74 for easy disposal. Since the release mechanism 46 is connected to the top portion 32 by the hinge 60, it remains connected to the vacuum cleaner 10 and easily reconnects to the magnetic elements 62 to start taking up magnetic materials 74 when the vacuum cleaner 10 is again in use.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claim.

What is claimed is:

1. A vacuum apparatus having a magnetic and coarse material uptake surface primer for separating magnetic materials, non-magnetic coarse materials, and fine materials from a surface, the apparatus comprising:
an intake housing having a magnetic element, a coarse material guide, a coarse material uptake portal and a fine material intake;
the coarse material uptake portal positioned between the magnetic element and the fine material intake;
a first storage chamber for holding the non-magnetic coarse materials; and
a release mechanism positioned such that the magnetic element adheres the magnetic materials to the release mechanism, and whereby moving the release mechanism away from the magnetic element permits the magnetic materials to separate from the magnetic element.

2. The apparatus of claim 1 wherein the release mechanism is a ferro-magnetic plate.

3. The apparatus of claim 1 wherein the release mechanism is hingedly coupled to the intake housing.

4. The apparatus of claim 1 further comprising a plurality of magnetic elements.

5. The apparatus of claim 1 wherein the release mechanism spans a front bumper of the intake housing.

6. The apparatus of claim 1 further comprising a coarse material guide between the magnetic element and the fine material intake.

7. The apparatus of claim 1 further comprising a pair of angled coarse material guides configured to direct the non-magnetic coarse materials toward the coarse material uptake portal.

8. The apparatus of claim 1 further comprising a second storage chamber.

9. The apparatus of claim 8 further comprising a coarse material uptake hose between the coarse material uptake portal and the first storage chamber.

10. The apparatus of claim further comprising a fine material uptake hose between the fine material intake and the second storage chamber.

11. A vacuum apparatus having a magnetic and coarse material uptake surface primer for separating magnetic materials, non-magnetic coarse materials, and fine materials from a surface, the apparatus comprising:
a main body portion having a coarse material storage chamber and a fine material storage chamber.
an intake housing having a top portion spanning a first sidewall and a second sidewall;
the top portion in fluid communication with the coarse material storage chamber and the fine material storage chamber;
the top portion further comprising a magnetic element configured to adhere the magnetic materials to a release mechanism, whereby moving the release mechanism away from the magnetic element causes the release mechanism to release the magnetic materials.

12. The apparatus of claim 11 wherein the release mechanism is a ferro-magnetic plate.

13. The apparatus of claim 11 wherein the release mechanism is hingedly coupled to the intake housing.

14. The apparatus of claim 11 further comprising a plurality of magnetic elements.

15. The apparatus of claim 11 wherein the release mechanism spans the first sidewall and the second sidewall.

16. The apparatus of claim 11 further comprising a coarse material guide between the magnetic element and the coarse material storage chamber.

17. The apparatus of claim 11 further comprising a pair of angled coarse material guides configured to direct the non-metallic coarse materials toward a coarse material vacuum uptake portal in communications with the coarse material storage chamber.

18. The apparatus of claim 11 wherein the first sidewall and the second sidewall extend beyond the top portion.

19. The apparatus of claim 11 wherein the coarse material storage chamber and the fine material storage chamber are in fluid communication with a common filter.

20. A method of providing an apparatus for removing and separating magnetic materials, non-magnetic coarse materials, and fine materials from a surface, the method comprising:
providing a motorized induction fan and filter;
providing a coarse material storage chamber and a fine material storage chamber;
providing a coarse material uptake portal and a fine material vacuum intake and configuring them such that the non-magnetic coarse materials encounter the coarse material uptake portal before the fine materials encounter the fine material vacuum intake when the apparatus passes across a surface;
providing a magnetic element and configuring it such that the magnetic materials encounter the magnetic element before the coarse material uptake portal and fine material vacuum intake when the apparatus passes across a surface; and
providing a release mechanism and configuring it such that moving the release mechanism away from the magnetic element releases the magnetic materials.
